(19) United States
(12) Patent Application Publication
(10) Pub. No.: US 2007/0281131 A1
(43) Pub. Date: Dec. 6, 2007

(54) COLOR DIELECTRIC EMBOSSING

(75) Inventors: David J. Dooley, Troy, MI (US); Randy S. Reed, Fair Haven, MI (US); Robert J. Adams, Ypsilanti, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/421,919

(22) Filed: Jun. 2, 2006

(51) Int. Cl. B32B 3/00; B05D 3/12

(52) U.S. Cl. 428/156; 428/172; 427/355

(57) ABSTRACT

A method of dielectrically embossing material comprising the steps of providing a dielectric embossing machine having a dielectric tool, providing a coloring agent, providing a material, applying the coloring agent to the dielectric tool, placing the material in the dielectric embossing machine, bringing the dielectric tool into contact with the material, energizing the dielectric tool, dielectrically embossing the material, de-energizing the dielectric tool, allowing the material and the coloring agent to cool, and backing the dielectric tool away from the material.

### BACKGROUND OF THE INVENTION

1. Field of the Invention

The present invention relates to a method of color embossing a material using a dielectric machine and a color embossed material made by that process.

2. Background Art

Examples of dielectric embossing are disclosed in U.S. Pat. Nos. 3,996,088; 4,380,519; 4,541,885; and 5,418,032.

### SUMMARY OF THE INVENTION

In accordance with at least one aspect of the present invention, a method of dielectrically embossing a material using a dielectric tool is provided. In at least one embodiment, the method comprises the steps of providing a dielectric embossing machine having a dielectric tool, providing a coloring agent, providing a material, applying the coloring agent to the dielectric tool, placing the material in the dielectric embossing machine, bringing the dielectric tool into contact with the material, energizing the dielectric tool, dielectrically embossing the material, de-energizing the dielectric tool, allowing the material and the coloring agent to cool, and removing the material from the dielectric embossing machine.

In at least one embodiment, the material to be embossed is in the form of a sheet. In at least another embodiment of the present invention, the coloring agent used to color the embossed portion of the material is a paint. In at least one embodiment, the dielectric tool comprises a male portion. In at least another embodiment, the dielectric tool comprises a female portion. In at least one embodiment, the step of applying the coloring agent to the dielectric tool is accomplished using a roller.

In at least one embodiment of the present invention, the material to be embossed is plastic. Suitable plastic materials include, but are not limited to, vinyls, or thermoplastic olefins.

In at least another embodiment of the present invention, the coloring agent is transferred to the material after the tool has been energized. In at least yet another embodiment of the present invention, the coloring agent is transferred to the material before the tool has been energized.

In at least one embodiment of the present invention, the embossed portion of the material has the appearance of stitching.

In accordance with at least another aspect of the present invention, a dielectrically embossed material is provided. In at least one embodiment, the dielectrically embossed material comprises a material having an outer surface that is at least partially embossed wherein the embossed portion is a different color than the rest of the outer surface of the material and wherein the differently colored embossed portion of the material is embossed by a method that is in accordance with one of the embodiments of the present invention.

In accordance with at least another aspect of the present invention, a dielectrically embossed interior automotive trim component is provided. In at least one embodiment, the dielectrically embossed interior automotive trim component comprises an interior automotive trim component having a show surface that is at least partially embossed wherein the embossed portion is a different color than the rest of the show surface and wherein the differently colored embossed portion is embossed by a method that is in accordance with one of the embodiments of the present invention.

In accordance with at least another aspect of the present invention, a method of dielectrically embossing a vinyl material using a dielectric tool is provided. In at least one embodiment, the method comprises the steps of providing a dielectric embossing machine having a dielectric tool, providing a coloring agent, providing a material comprising a vinyl, applying the coloring agent to the dielectric tool, placing the material in the dielectric embossing machine, bringing the dielectric tool into contact with the material, energizing the dielectric tool, dielectrically embossing the material, de-energizing the dielectric tool, allowing the material and the coloring agent to cool, backing the dielectric tool away from the material, and removing the material from the dielectric embossing machine.

In another embodiment of the dielectrically embossed vinyl material, the coloring agent can be a paint. In at least another embodiment, the embossed portion of the vinyl material can have the appearance of stitching.

In accordance with at least another aspect of the present invention, a method of dielectrically embossing an interior automotive trim component is provided. In at least one embodiment, the method comprises the steps of providing a dielectric embossing machine having a dielectric tool, providing a coloring agent, providing a plastic interior automotive trim component, applying the coloring agent to the dielectric tool, placing the plastic interior automotive trim component in the dielectric embossing machine, bringing the dielectric tool into contact with a plastic interior automotive trim component, energizing the dielectric tool, dielectrically embossing the plastic interior automotive trim component, de-energizing the dielectric tool, allowing the plastic interior automotive trim component and the coloring agent to cool, backing the dielectric tool away from the plastic interior automotive trim component, and removing the plastic interior automotive trim component from the dielectric embossing machine.

In another embodiment of the method for dielectrically embossing an interior automotive trim component, the embossed portion of the plastic interior automotive trim component has the appearance of stitching or any decorative feature. In at least one other embodiment of the dielectrically embossed interior trim automotive trim component, the coloring agent is a paint.

While exemplary embodiments in accordance with the invention are illustrated and disclosed, such disclosures should not be construed to limit the claims. It is anticipated that various modifications and alternative designs may be made without departing from the scope of the invention.

### BRIEF DESCRIPTION OF THE DRAWINGS

FIG. 1 is a schematic view of a dielectric embossing machine useable in accordance with at least one embodiment of the present invention;

FIG. 2 is a schematic view showing the application of a coloring agent to a dielectric tool of the machine illustrated in FIG. 1;

FIG. 3 is a schematic view showing material positioned in the dielectric embossing machine and the dielectric embossing machine closing;

FIG. 4 is a schematic view showing the dielectric embossing machine in the closed position; and

FIG. 5 is a schematic view showing the dielectric embossing machine opening, revealing the embossed material.

### DETAILED DESCRIPTION OF THE ILLUSTRATED EMBODIMENT(S)

The following descriptions are merely exemplary in nature and are in no way intended to limit the invention, its application, or uses.

Reference will now be made in detail to the presently preferred compositions, embodiments, and methods of the present invention which constitute the best modes of practicing the invention presently known to the inventors. The figures are not necessarily drawn to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

In at least one embodiment, the present invention relates to a method of embossing a material using a dielectric embossing machine to impart not only topographical features to the material, but also to impart color to the embossed portion of the material. Dielectric embossing using a dielectric embossing machine is known in the automotive industry. A dielectric machine generally comprises a tool mounting portion, a plate, and a dielectric tool. A dielectric embossing process can entail placing the material to be embossed in the dielectric embossing machine between the plate and the tool mounting portion. The tool mounting portion and the plate are then brought together such that the dielectric tool comes into contact with the material to be embossed. At that point, the dielectric machine is typically energized causing the tool mounting portion to generate radio waves which are transmitted from the dielectric tool to the plate, passing through the material. The transmission of radio waves through the material causes localized heating of the material in the area where the radio waves pass. The material typically softens or melts in response to heat. In the typical process, the heat causes the material to liquify, melt, or otherwise become malleable. Materials suitable for dielectric embossing include plastics such as vinyls, thermoplastic olefins, thermoplastic urethanes, thermoplastic elastomers, polyethylenes, and polyvinylchlorides.

With the dielectric embossing machine energized in the closed position, and the dielectric tool in contact with the material, as the material liquifies, melts, or otherwise becomes malleable, it takes the form of the dielectric tool similar to the way in which molten plastic takes the form of a cavity into which it is injected during a plastic injection molding process. This causes the surface of the material to have both raised and depressed features.

The machine is then de-energized and the material, now embossed, is permitted to cool and solidify. Once the material is sufficiently cooled, the dielectric embossing machine is opened, and the embossed material can be removed. This process for dielectrically embossing a material results in embossed features which are the same color as the non-embossed portions of the material.

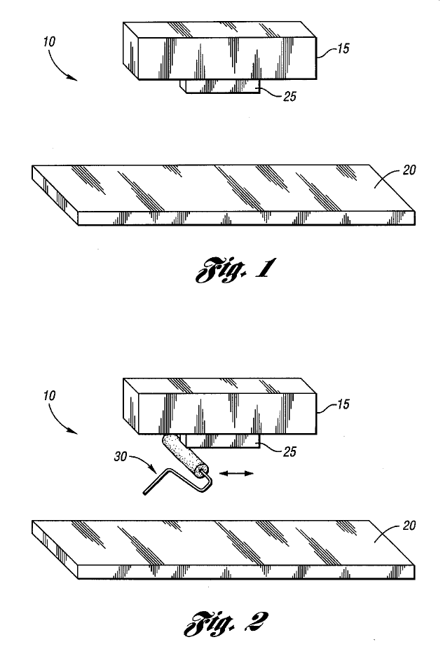

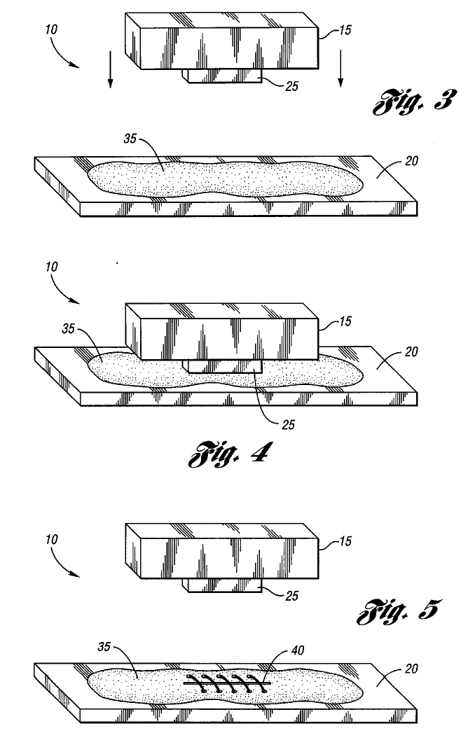

The present invention produces a dielectrically embossed material having embossed features that are a different color than the remainder of the material. Referring to FIG. 1, a dielectric machine 10 is provided having a tool mounting portion 15, a plate 20, and a dielectric tool 25 which could be either male or female, or both. Prior to placing material in the dielectric embossing machine, a coloring agent is applied to the dielectric tool 25 in any suitable manner. In at least one embodiment of the present invention, shown in FIG. 2, a roller 30 can be used to apply the coloring agent to the dielectric tool 25. This can be accomplished by applying the coloring agent to the roller and then rolling the roller across the portion of the surface of the dielectric tool that will contact the material when the tool closes. In at least another embodiment, the coloring agent could be applied by spraying. The coloring agent can be any suitable coloring agent such as paint. Once the coloring agent has been applied to the dielectric tool 25, the material 35 to be embossed is placed in the dielectric embossing machine 10 in between the plate 20 and the tool mounting portion 15 and positioned so that when the tool mounting portion 15 and the plate 20 are brought together, the dielectric tool 25 will come into contact with the material 35, as shown in FIG. 3. Once the material 35 is properly positioned, the tool mounting portion 15 and the plate 20 can be brought together, as shown in FIGS. 3 and 4. The material 35 can be made of any suitable plastic and typically comprises a cover stock which, subsequent to the dielectric embossing, will be mounted on a rigid substrate.

Once the tool mounting portion 15 has closed over the material 35 and the dielectric tool 25 is in contact with the material 35, as shown in FIG. 4, the dielectric embossing machine 10 is turned on (energized), thus transmitting radio waves from the dielectric tool 25 to the plate 20. This causes localized heating of the portions of the material 35 that are in contact with the dielectric tool 25, causing such portions to liquify, melt or otherwise become malleable and take the shape of the dielectric tool 25. The dielectric tool 25 can be male, female, or both. With the dielectric embossing machine 10 in the closed position, and with the dielectric tool 25 in contact with the material 35, the coloring agent on the surface of the dielectric tool 25 is at least partially transferred to the portion of the material 35 that is to be embossed. A portion of the coloring agent may be transferred to the surface of the dielectric tool 25 by virtue of the surface of the dielectric tool 25 contacting the surface of the material 35. The coloring agent may also be transferred while the dielectric embossing machine 10 is energized, causing the material 35 to soften or liquify and take the shape of the tool, thereby contacting the entire surface of the dielectric tool 25. While the dielectric embossing machine 10 is transmitting radio waves and the material 35 is heated, the coloring agent can cure.

The dielectric machine 10 is then de-energized, and the material 35 is allowed to cool and re-solidify during which period the coloring agent may continue to cure. As shown in FIG. 5, the tool mounting portion 15 is then lifted off the plate 20, opening the dielectric machine 10 to reveal the colored dielectrically embossed portion 40 of the material 35. At this point in the process, the material 35 may be removed from the dielectric embossing machine 10.

As seen in FIG. 5, in at least one embodiment of the present invention, the embossed pattern 40 can have the appearance of stitching. This can be useful when the embossed material is used as an interior automotive trim component or to cover a component used as interior automotive trim because the appearance of stitching on such components can be aesthetically pleasing. Where the embossed stitching is a different color than the remainder of the material, it enhances the realistic appearance of the embossed stitching, thus contributing further to the aesthetically pleasing appearance of the embossing.

While embodiments of the invention have been illustrated and described, it is not intended that these embodiments illustrate and describe all possible methods and forms of the invention. Rather, the words used in the specification are words of description rather than limitation, and it is understood that various changes may be made without departing from the spirit and scope of the invention.

What is claimed is:

1. A method of dielectrically embossing a material comprising the steps of:
providing a dielectric embossing machine having a dielectric tool;
providing a coloring agent;
providing a material;
applying the coloring agent to the dielectric tool;
placing the material in the dielectric embossing machine;
bringing the dielectric tool into contact with the material;
energizing the dielectric tool;
dielectrically embossing the material;
de-energizing the dielectric tool;
allow the material and coloring agent to cool; and
removing the material from the dielectric embossing machine.

2. The method of claim 1 wherein the material is in the form of a sheet.

3. The method of claim 1 wherein the coloring agent is a paint.

4. The method of claim 1 wherein the dielectric tool comprises a male portion.

5. The method of claim 1 wherein the step of applying the coloring agent to the dielectric tool is accomplished using a roller.

6. The method of claim 1 wherein the material comprises a plastic.

7. The method of claim 6 wherein the material comprises a vinyl.

8. The method of claim 1 wherein the coloring agent is transferred to the material after the tool has been energized.

9. The method of claim 1 wherein the coloring agent is transferred to the material before the tool has been energized.

10. The method of claim 6 wherein the material comprises thermoplastic olefins.

11. The method of claim 1 wherein the embossed portion of the material has the appearance of stitching.

12. The method of claim 1 wherein the dielectric tool comprises a female portion.

13. A dielectrically embossed material comprising:
a material having an outer surface that is at least partially embossed;
wherein the embossed portion is a different color than the rest of the outer surface; and
wherein the differently colored embossed portion is embossed by the method of claim 1.

14. A dielectrically embossed interior automotive trim component comprising:
an interior automotive trim component having a show surface that is at least partially embossed;
wherein the embossed portion is a different color than the rest of the show surface; and
wherein the differently colored embossed portion is embossed by the method of claim 1.

15. A method of dielectrically embossing a vinyl material comprising the steps of:
providing a dielectric embossing machine having a dielectric tool;
providing a coloring agent;
providing a material comprising a vinyl;
applying the coloring agent to the dielectric tool;
placing the material in the dielectric embossing machine;
bringing the dielectric tool into contact with the material;
energizing the dielectric tool;
dielectrically embossing the material;
de-energizing the dielectric tool;
allowing the material and the coloring agent to cool;
backing the dielectric tool away from the material; and
removing the material from the dielectric embossing machine.

16. The method of claim 15 wherein the coloring agent is a paint.

17. The method of claim 15 wherein the embossed portion of the material has the appearance of stitching.

18. A method of dielectrically embossing an interior automotive trim component comprising the steps of:
providing a dielectric embossing machine having a dielectric tool;
providing a coloring agent;
providing a plastic interior automotive trim component;
applying the coloring agent to the dielectric tool;
placing the plastic interior automotive trim component in the dielectric embossing machine;
bringing the dielectric tool into contact with the plastic interior automotive trim component;
energizing the dielectric tool;
dielectrically embossing the plastic interior automotive trim component;
de-energizing the dielectric tool;
allowing the plastic interior automotive trim component and the coloring agent to cool;
backing the dielectric tool away from the plastic interior automotive trim component; and
removing the plastic interior automotive trim component from the dielectric embossing machine.

19. The method of claim 18 wherein the embossed portion of the plastic interior automotive trim component has the appearance of stitching.

20. The method of claim 19 wherein the coloring agent is a paint.
